(19) United States
(12) Patent Application Publication
(10) Pub. No.: US 2006/0208096 A1
(43) Pub. Date: Sep. 21, 2006

(54) Flash memory expansion device & method

(76) Inventor: Sheng-Fa Chang, Chung-he City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/298,462

(22) Filed: Dec. 12, 2005

(30) Foreign Application Priority Data
Mar. 19, 2005 (TW) 094106160

(51) Int. Cl. G06K 19/06; G06K 7/06

(52) U.S. Cl. 235/492; 235/441

(57) ABSTRACT

A flash memory expansion device and method providing expanded capacity and allowing data exchange between two memory devices without depending on a computer; the device including control, memory, connection, operation, display, and power supply unit; both devices being plugged to each other, operation unit of the first device reads through its control unit data from the first device and that from the memory unit in the second device while having the data in its memory unit stored in that of the second device through the connection unit in the first device and the control unit in the second device, or vice versa.

### FIELD OF THE INVENTION

The present invention is related to an expansion device and expansion method for a flash memory, and more particularly, to a device provided with expanded capacity and a method allowing data exchange between two memories without depending on a computer.

### BACKGROUND OF THE INVENTION

Flash memory device (also known as the pen drive) generally available in the market usually provides function of A/V, text, and graphic data storage. To save and read data by the flash memory device, or to execute data exchange for storage between two flash memory devices, it takes to connect USB interfaces from both memory devices to a computer before executing data transmission. For data exchange and storage between two flash memory devices, it takes first to save the data stored in the first memory device in the computer, connect the second memory device to the same computer to transmit and save the data into the second memory device. Accordingly, it is impossible for the user to complete data exchange for storage between two flash memory devices saving the computer. Furthermore, the storage space is limited in a flash memory device and it prevents further expansion once the storage space is used up.

### SUMMARY OF THE INVENTION

The primary purpose of the present invention is to provide a memory with expanded capacity and a method for the memory to communicate with another memory for data exchange without depending on a computer.

To achieve the purpose, a flash memory expansion device of the present invention is comprised of a control unit, a memory unit, a connect unit, an operation unit, a display unit and a power supply unit; and a first memory device and a second memory device are plugged into each other by means of connectors and sockets for the operation unit of the first memory device using its control unit reads data from the memory units of both memory devices, and stores data in its memory unit into the memory unit of the second memory device by means of the connection unit of the first memory device and the control unit of the second memory device, or vice versa.

### BRIEF DESCRIPTION OF THE DRAWINGS

FIG. 1 is a schematic view showing a configuration of a memory device of the present invention.

FIG. 2 is a schematic view of an operation status of the present invention.

FIG. 3 is a schematic view of another operation status of the present invention.

### DETAILED DESCRIPTION OF THE PREFERRED EMBODIMENTS

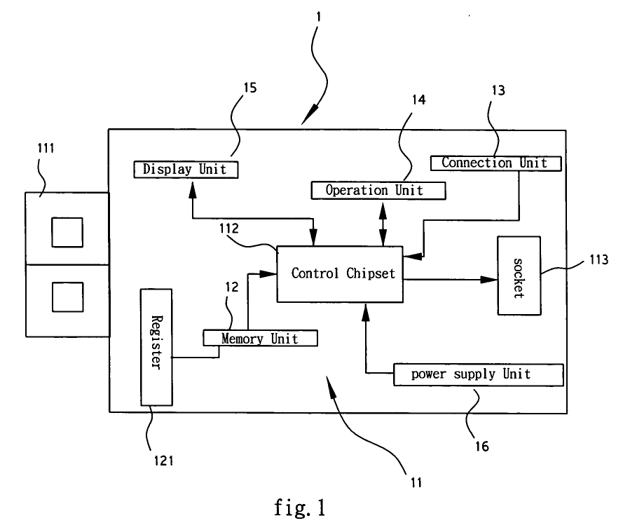

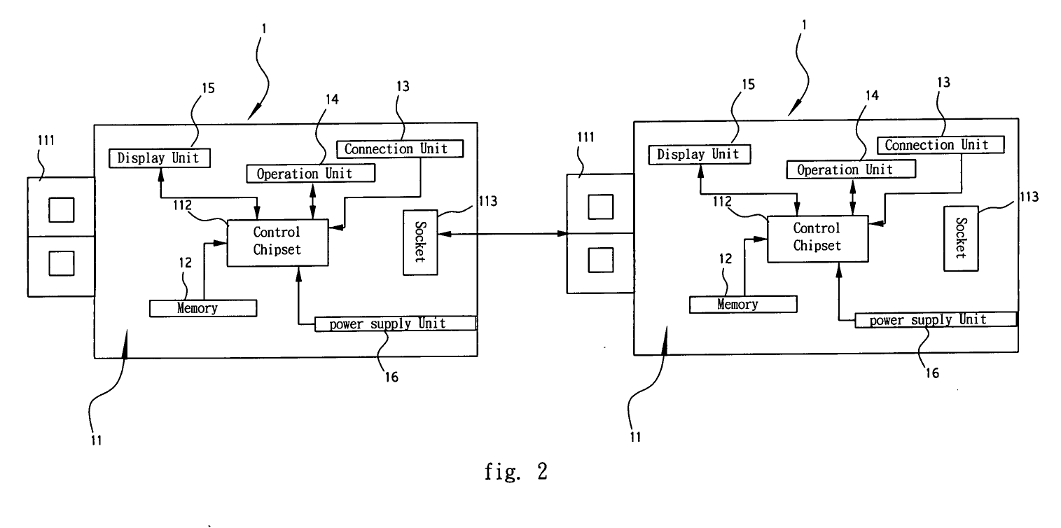

Referring to FIGS. 1 and 2 for a configuration and operating status of a preferred embodiment of the present invention, a memory device 1 is provided with expanded capacity while allowing the memory device 1 and another memory device la to exchange data without depending on a computer. The memory device 1 is comprised of a control unit 11, a memory unit 12, a connection unit 13, an operation unit 14, a display unit 15, and a power supply unit 16. The control unit 11 includes a USB connector 111, a socket 113, and a control chipset 112.

The memory unit 12 in NAND Flash format is connected to the control unit 11 to provide data storage space, and to a register 121.

The connection unit 13 connected to the control unit 11 is provided for connection to an external electronic device, e.g., a memory card, bluetooth or radio receiver to function as a card reader or radio transmission.

The operation unit 14 connected to the control unit 11 serves as the operation interface to communicate commands between the user and the memory device 1, thus for the user to select functional options available with the memory device 1.

The display unit 15 connected to the control unit 11 functions to display the functional option selected by the operation unit 14.

The power supply unit 16 supplies power needed to operate the memory device 1.

The present invention operates in the following steps:

a. A first memory device 1 and a second memory device 1a are provided with a connector 111a from the second memory device plugged into the socket 113 of the first memory device;

b. The display unit 15 of the first memory device 1 displays if the connection with the second memory device 1a as detected is successful or not;

c. The operation unit 14 of the first memory device 1 reads through its control unit 11 the data stored in the memory unit 12 of the first memory device 1, and enters through the first memory device 1 into the second memory device la to read data stored in a memory unit 12a of the second memory device 1a by taking advantage of a control unit 11a of the second memory device la with data so read being displayed by the display unit 5 of the first memory device 1; and

d. After the operation unit 14 of the first memory device 1 has read the data stored in the memory unit 12 of the first memory device 1 through its control unit 11, the data in the memory unit 12 of the first memory device 1 are stored in the memory unit 12a of the second memory unit 1a through the connection unit 13 of the first memory device 1 and the control unit 11a of the second memory device 1a; or similarly, the data in the memory unit 12a of the second memory device 1a are stored in the memory unit 12 of the first memory device 1.

Furthermore, a third memory device in the same construction as that of the first memory device 1 or the second memory device la is plugged to the connection unit 13a of the second memory device 1a; or alternatively, both of the first and the second memory devices 1, 1a are forthwith plugged into each other before being plugged into the computer for use to provide expanded capacity and better use of the present invention.

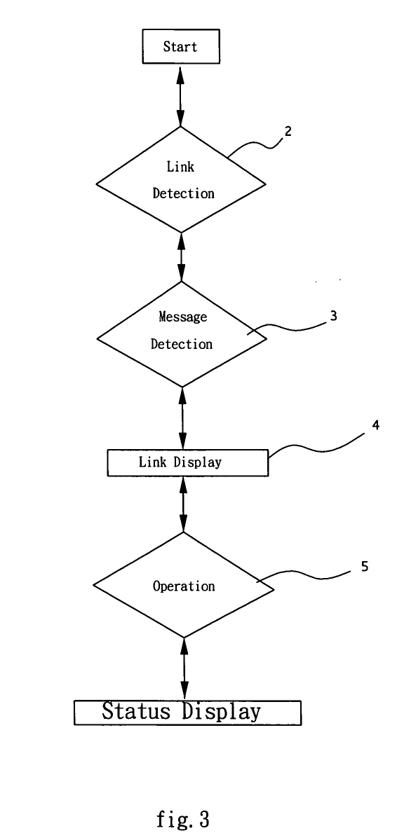

Now referring to FIG. 3 for another operating status of the present invention, the connection unit 13 of the first memory device 1 is externally connected to an electronic device to function as a bluetooth or a radio receiver in the following steps:

Link detection 2: connection is made to an electronic appliance (e.g., a computer, a handset, a PDA, etc., not illustrated) for a micro-processor built in the electronic appliance to detect one by one while displaying if link is made to a built-in storage memory segment and peripherals.

Message detection 3: the electronic appliance detects for bluetooth or radio receiver.

Link Display 4: the electronic appliance displays a radio device as detected.

Operation 5: the proper operation interface is pressed as applicable for the use.

Status display 6: data input/output status is displayed, followed with the picture indicating the completion of the data input/output.

Accordingly, the present invention by taking advantage of its connection unit 13 to connect to an external electronic device functions as bluetooth or radio receiver, thus to make the present invention more adaptable in meeting the practical use.

The prevent invention by providing expansion device and method for a flash memory to expand the capacity of the memory device and allow data exchange between two memory devices without depending on a computer is advanced, practical and better meeting the demands of the user, therefore this application for a patent is duly filed accordingly. However, it is to be noted that the preferred embodiments disclosed in the specification and the accompanying drawings are not limiting the present invention; and that any construction, installation, or characteristics that is same or similar to that of the present invention should fall within the scope of the purposes and claims of the present invention.

What is claimed is:

1. A flash memory expansion device, the flash memory includes:
a control unit, including a USB connector, a socket, and a control chipset;
a memory unit in NAND Flash format, connected to the control unit to serve data storage space;
a connection unit, connected to the control unit for connection to another electronic device;
an operation unit, connected to the control unit, serving as the operation interface for the communication of commands between the user and the memory device for the user to select functional options available from the memory device;
a display unit, connected to the control unit, displaying functional option selected by the operation unit; and
a power supply unit to supply power to the memory device.

2. The flash memory expansion device of claim 1, wherein the memory unit is connected to a register.

3. The flashmemory expansion device of claim 1, wherein the electronic device relates to a memory card.

4. The flash memory expansion device of claim 1, wherein the electronic device relates to a bluetooth or radio receiver.

5. A method for the expansion of the flash memory includes the following steps:
a. A first memory device and a second memory device are provided with a connector from the second memory device plugged into the socket of the first memory device;
b. The display unit of the first memory device displays if the connection with the second memory device as detected is successful or not;
c. The operation unit of the first memory device reads through its control unit the data stored in the memory unit of the first memory device, and enters through the first memory device into the second memory device to read data stored in a memory unit of the second memory device by taking advantage of a control unit of the second memory device with data so read being displayed by the display unit of the first memory device; and
d. After the operation unit of the first memory device has read the data stored in the memory unit of the first memory device through its control unit, the data in the memory unit of the first memory device are stored in the memory unit of the second memory unit through the connection unit of the first memory device and the control unit of the second memory device; or similarly, the data in the memory unit of the second memory device are stored in the memory unit of the first memory device.
